(19) United States
(12) Patent Application Publication
(10) Pub. No.: US 2026/0019133 A1
(43) Pub. Date: Jan. 15, 2026

(54) METHODS AND DEVICES FOR SIGNAL DISTRIBUTION

(71) Applicant: Telefonaktiebolaget LM Ericsson (publ), Stockholm (SE)

(72) Inventors: Henrik SJÖLAND, Lund (SE); Fabien MESQUITA, Limhamn (SE)

(21) Appl. No.: 18/881,898

(22) PCT Filed: Jul. 7, 2022
(86) PCT No.: PCT/EP2022/068914

§ 371 Date: Jan. 7, 2025

(51) Int. Cl. H04B 7/06

(52) U.S. Cl. CPC H04B 7/0671; H04B 7/0617

(57) ABSTRACT

A distribution device for distribution a digital data signal and an associated clock signal to a plurality of sub-nodes. The distribution device includes an obtaining circuit configured to obtain the digital data signal, the clock signal and a beam control signal. The beam control signal indicates a target beam direction for the digital data signal. The distribution device further includes a delaying circuit, configured to, individually for one or more of the plurality of sub-nodes, delay the digital data signal and the clock signal based on the beam control signal and thereby provide a delayed digital data signal and a delayed clock signal. The distribution device further includes a provisioning circuit, configured to provide the delayed digital data signal and the delayed clock signal to the respective one or more of the plurality of sub-nodes.

### TECHNICAL FIELD

The present disclosure relates to distribution of signals, and more precisely to distribution of signals for beamforming.

### BACKGROUND

With the increased utilization of frequency spectrum in wireless communication, numerous methods and technologies have been developed to decrease interference between different wireless entities and to increase the energy efficiency of the communication. One commonly used technology is transmitter beamforming.

In transmitter beamforming, the transmitting entity comprises a plurality of antenna elements configured to form an antenna array. Generally, each antenna element is provided with an individual radio frequency (RF) signal, and a direction of a resulting beam is controlled by introducing controllable time delays of each of the RF signals. Generally, phase-shifters are used to emulate the delay in time for reasons relating to e.g. configurability, cost, power consumption and design area. However, when using phase-shifters at a given relative bandwidths (RBW), i.e. a ratio between the a bandwidth (BW) and a central frequency, of the RF signals; a time delay provided by a phase-shift will be different at a lower end of the BW compared to an upper end of the BW. This will introduce an error in steering of the beam direction that is known as beam squint and this effect will increase with increased RBW.

Time delay components introduce a true delay in time and are compatible with a comparably large RBW. However, implementation of a these delay components are very costly in terms of power consumption, chip area, and dynamic range loss, specifically at high frequencies. A range of the delay should preferably cover the time of arrival difference from a time when a first antenna element receives a plane wave, until a time when a last antenna element is receives the same wave. This amounts to several periods of the carrier frequency in a large antenna array.

### SUMMARY

It is in view of the above considerations and others that the various embodiments of this disclosure have been made. The present disclosure therefore recognizes the fact that there is a need for alternatives to (e.g. improvement of) the existing art described above.

It is an object of some embodiments to solve, mitigate, alleviate, or eliminate at least some of the above or other disadvantages. In doing so, the present disclosure provides a new type of distribution device which is improved over prior art and which eliminates or at least mitigates the drawbacks discussed above. More specifically, an object of the invention is to provide a distribution device that introduces delays to the distributed signals to reduce the effect of beam squint. These objects are achieved by the technique set forth in the appended independent claims with preferred embodiments defined in the dependent claims related thereto.

In a first aspect, a distribution device for distribution a digital data signal and an associated clock signal to a plurality of sub-nodes is presented. The distribution device comprises an obtaining circuit configured to obtain the digital data signal, the clock signal and a beam control signal indicating a target beam direction for the digital data signal. The distribution device further comprises a delaying circuit that is configured to, individually for one or more of the plurality of sub-nodes, delay the digital data signal and the clock signal based on the beam control signal, thereby providing a delayed digital data signal and a delayed clock signal; and a provisioning circuit, configured to provide the delayed digital data signal and the delayed clock signal to the respective one or more of the plurality of sub-nodes.

In one variant, the distribution device further device comprises a delay locked loop, DLL, configured to align a signal delay to the one or more of the plurality of sub-nodes in relation to a period of the clock signal. This is beneficial as it increases the absolute accuracy of the delays introduced by the distribution device

In one variant, the distribution further device comprises a DLL configured to adjust a difference in the signal delay between two or more of the plurality of sub-nodes in relation to the period of the clock signal. This is beneficial as it increases the relative accuracy of the delays introduced by the distribution device.

In one variant, the provisioning circuit is further configured to provide the beam control signal to the respective one or more of the plurality of sub-nodes. This is beneficial as it allows for the adaptation of the beam control signals based on the delay introduced by the distribution device.

In one variant, the digital data signal is obtained on a parallel interface. This is beneficial as the transfer rate of the digital data signal is increased.

In a second aspect, a distribution arrangement is presented. The distribution arrangement comprises a distribution device of the first aspect and a first plurality of sub-nodes connected to the distribution arrangement.

In one variant, the first plurality of sub-nodes are located at substantial equal distances from the distribution device. This is beneficial as it provides substantially equal transmission delays from the distribution device to each of the sub-nodes in the first plurality of sub-nodes.

In one variant, the first plurality of sub-nodes are substantially symmetrically arranged about the distribution device. This is beneficial as it provides a symmetrical distribution of the digital data signal and the clock signal which provides efficient, accurate and convenient control of a resulting beam direction.

In one variant, at least a first sub-node of a first plurality of sub-nodes is connected to a second plurality of sub-nodes. The first sub-node comprises a distribution device according to the first aspect. This is beneficial as it allows for a layered, or levelled, design where the signals may be distributed in a tree-like manner.

In a third aspect, a distribution assembly is presented. The distribution assembly comprises the distribution device according to the first aspect and a plurality of distribution arrangements according to the second aspect connected to the distribution device.

In one variant, the plurality of distribution arrangements are located at substantial equal distances from the distribution device. This is beneficial as it provides substantially equal transmission delays from the distribution device to each of the distribution arrangements.

In one variant, the plurality of distribution arrangements are substantially symmetrically arranged about the distribution device. This is beneficial as it provides a symmetrical distribution of the digital data signal and the clock signal which provides efficient, accurate and convenient control of a resulting beam angle.

In a fourth aspect, a beamforming device is presented. The beamforming device comprises the distribution arrangement according to the third aspect, wherein at least one of the sub-nodes is a leaf-node. The leaf-node comprises a conversion circuit clocked by the delayed clock signal and configured to convert the delayed digital signal to an analog data signal, and a mixing circuit, configured to mix the analog data signal with a carrier frequency signal, thereby providing a modulated carrier frequency signal.

In one variant, the leaf-node further comprises a beamforming circuit, configured to phase-shift the modulated carrier frequency signal based on the beam control signal. This is beneficial as it allows for further fine-tuning of a resulting beam direction and it allows for the delay delayed digital data signal and the delayed clock signal to be delayed by fractions of a period time of the carrier frequency.

In one variant, the beamforming circuit is configured to phase-shift the modulated carrier frequency signal based on a residual beam control signal, wherein the residual beam control signal is determined based on the beam control signal and the delay introduced to the digital data signal and the clock signal by the delaying circuit of the distribution circuit when providing the delayed digital data signal and the delayed clock signal. This is beneficial as it allows for further fine-tuning of a resulting beam direction and it allows for the delay delayed digital data signal and the delayed clock signal to be delayed by fractions of a period time of the carrier frequency.

In one variant, the beamforming device further comprises a carrier phase-shifting circuit configured to subject the carrier frequency signal to a phase-shift corresponding to the delay introduced to the digital data signal and the clock signal by the delaying circuit when providing the delayed digital data signal and the delayed clock signal. The phase shift is introduced to the carrier frequency prior to the carrier frequency signal being provided to the mixing circuit. This is beneficial as it allows for further fine-tuning of a resulting beam direction and it allows for the delay delayed digital data signal and the delayed clock signal to be delayed by fractions of a period time of the carrier frequency.

In one variant, the leaf-node further comprises a filtering circuit, configured to filter the analog data signal, and an amplifier, configured to amplify the phase-shifted analog data signal. In once variant, the beamforming device comprises a plurality of beamforming circuits and amplifiers, wherein each beamforming circuit is configured to be operatively connected to an antenna element. This is beneficial as it allows the leaf-node to provide individual signals to a plurality of antenna element,

In one variant, a relative bandwidth (RBW) of the modulated carrier frequency signal is above 1%, preferably above 3% and more preferably above 5%.

In a fifth aspect, an integrated circuit comprising the beamforming device of the fourth aspect is presented.

In a sixth aspect, a beamforming assembly comprising the beamforming device according to the fourth aspect is presented. The beamforming assembly further comprises an antenna array sectioned into a plurality of subgroups, wherein each of the subgroups comprises an antenna element connected to a respective leaf-node of the beamforming device.

In one variant, at least one of the subgroups comprise a plurality of antenna elements connected to the respective leaf-node of the beamforming device. This is beneficial as it allows for a cost effective, comparably small and low power consumption beamforming assembly to be provided.

In a seventh aspect, an apparatus comprising the beamforming device according to the fourth aspect is presented.

In one variant, the network node is a wireless device.

In one variant, the network node is a base station (BS).

In an eighth aspect, a method for distributing a digital data signal and an associated clock signal to a plurality of sub-nodes is presented. The method comprises the obtaining of the digital data signal, the clock signal, and a beam control signal indicating a target beam direction for the digital data signal. It further comprises the delaying of, individually for one or more of the plurality of sub-nodes, the digital data signal and the clock signal based on the beam control signal, thereby providing a delayed digital data signal and a delayed clock signal. Further to this, the method comprises the provisioning of the delayed digital data signal and the delayed clock signal to the respective one or more of the plurality of sub-nodes.

In one variant, the method further comprises calibration of a first signal delay to adjust for a signal delay to one or more of the plurality of sub-nodes in relation to a period of the clock signal. This is beneficial as it increase the absolute accuracy of the delay introduced by the method.

In one variant, the method further comprises calibration of a second signal delay to adjust for a difference in the signal delay between two or more of the plurality of sub-nodes in relation to a period of the clock signal. This is beneficial as it increase the relative accuracy of the delay introduced by the method.

In one variant, the method further comprises, for at least one of the sub-nodes, phase-shifting, a carrier frequency signal for subsequent mixing of an analog representation of the associated delayed digital signal, with a phase-shift corresponding to the delay introduced to the digital data signal and the clock signal when providing the delayed digital data signal and the delayed clock signal. This is beneficial as it allows for further fine-tuning of a resulting beam direction and it allows for the delay delayed digital data signal and the delayed clock signal to be delayed by fractions of a period time of the carrier frequency.

### BRIEF DESCRIPTION OF THE DRAWINGS

These and other aspects, features and advantages will be apparent and elucidated from the following description of various embodiments; references being made to the appended diagrammatical drawings which illustrate non-limiting examples of how the concept can be reduced into practice.

FIGS. 1a-b are top views of an antenna array according to some embodiments of the present disclosure;

FIG. 1c is a side view of an antenna array according to some embodiments of the present disclosure;

FIG. 2 is a schematic view of a distribution arrangement according to some embodiments of the present disclosure;

FIG. 3 is a schematic view of a distribution device according to some embodiments of the present disclosure;

FIG. 4 is a schematic view of a distribution device according to some embodiments of the present disclosure;

FIGS. 5a-b are schematic views of leaf-nodes according to some embodiments of the present disclosure;

FIG. 6 is a schematic view of a sub-node according to some embodiments of the present disclosure;

FIG. 7 is a schematic view of a distribution arrangement according to some embodiments of the present disclosure;

FIG. 8 is a schematic view of a distribution assembly according to some embodiments of the present disclosure;

FIGS. 9a-b are schematic layout-views of distribution arrangements according to some embodiments of the present disclosure;

FIG. 10a is a schematic layout-view of a distribution arrangement according to some embodiments of the present disclosure;

FIG. 10b is a partial schematic layout-view of a distribution arrangement according to some embodiments of the present disclosure;

FIGS. 11a-b are schematic views of beamforming devices according to some embodiments of the present disclosure;

FIGS. 12a-b are schematic views of beamforming assemblies according to some embodiments of the present disclosure;

FIG. 13a is a schematic view of an integrated circuit according to some embodiments of the present disclosure;

FIG. 13b is a schematic view of a beamforming assembly according to some embodiments of the present disclosure;

FIGS. 14a-b are views of apparatuses according to some embodiments of the present disclosure; and

FIG. 15 is a block diagram view of a method for signal distribution according to some embodiments of the present disclosure.

### DETAILED DESCRIPTION

Hereinafter, certain embodiments will be described more fully with reference to the accompanying drawings. The invention described throughout this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Two or more items that are “coupled” may be integral with each other. The terms “a” and “an” are defined as one or more unless this disclosure explicitly requires otherwise. The terms “substantially,” “approximately,” and “about” are defined as largely, but not necessarily wholly what is specified, as understood by a person of ordinary skill in the art. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps.

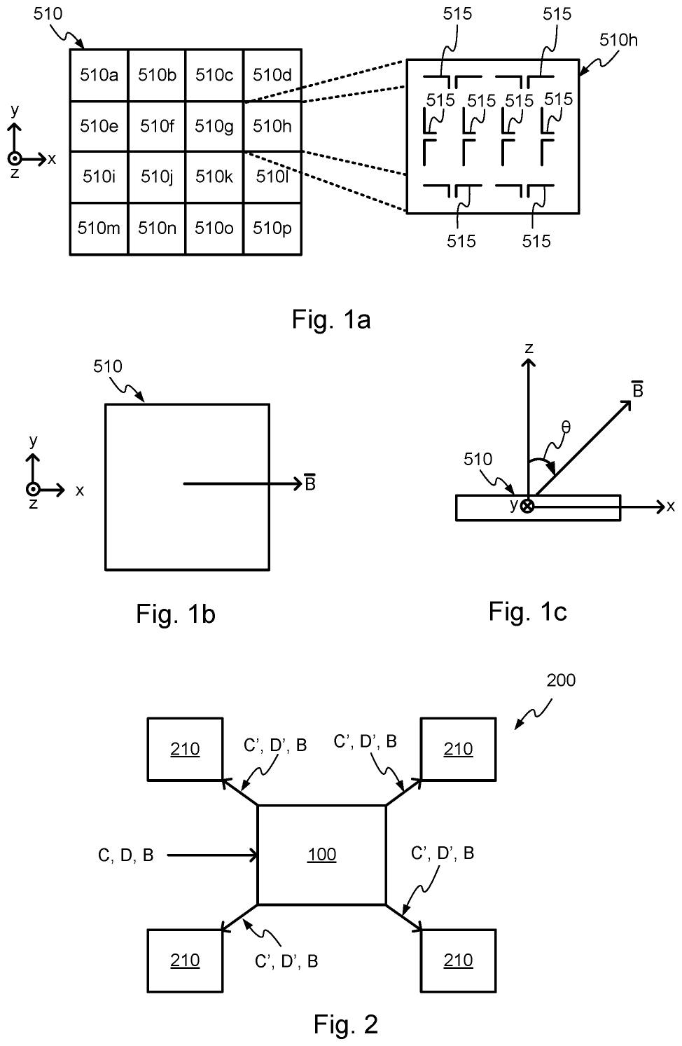

With reference to FIGS. 1a-c, a general introduction to the teachings of the present disclosure will be given. In FIG. 1a, an antenna array 510 is shown in a top view, looking down along a z-axis in a xyz-coordinate system. The antenna array 510 is divided into a plurality of subgroups 510a, . . . , 510p, where each subgroup comprises one or more antenna elements 515. This is illustrated in FIG. 1a with an enlarged view of a h:th subgroup 510h comprising eight antenna element 515 arranged in two different orientations, one along an x-axis and one along a y-axis, i.e. mutually 90° apart. As is known in the art, by providing each of the antenna elements 515 and/or the subgroups 510a, . . . , 510p with signals being differently delayed in time, a beam direction B̅ may be controlled. This is shown in FIG. 1b, where the antenna array 510 is illustrated in the corresponding view as that of FIG. 1a; and in FIG. 1c, where the antenna array 510 is illustrated in a view that is rotated 90° around the x-axis such that the antenna array 510 is seen looking along the y-axis. In FIGS. 1b and c, the antenna array 510 is configured to provide a beam direction B̅ in an xz-direction forming a beam-steering angle θ to the x-axis. The beam direction B̅ of FIGS. 1b and c may be provided by introducing a time delay to the subgroups 510a, . . . , 510p of the antenna array 510 depending on their location long the x-axis. In this particular example, this may entail not delaying the signals for a first column of subgroups 510a, 510e, 510i, 510m, delaying a second column of subgroups 510b, 510f, 510j, 510n, further delaying a third column of subgroups 510c, 510g, 510k, 5100 and delaying a fourth column of subgroups 510d, 510h, 510f, 510p the most.

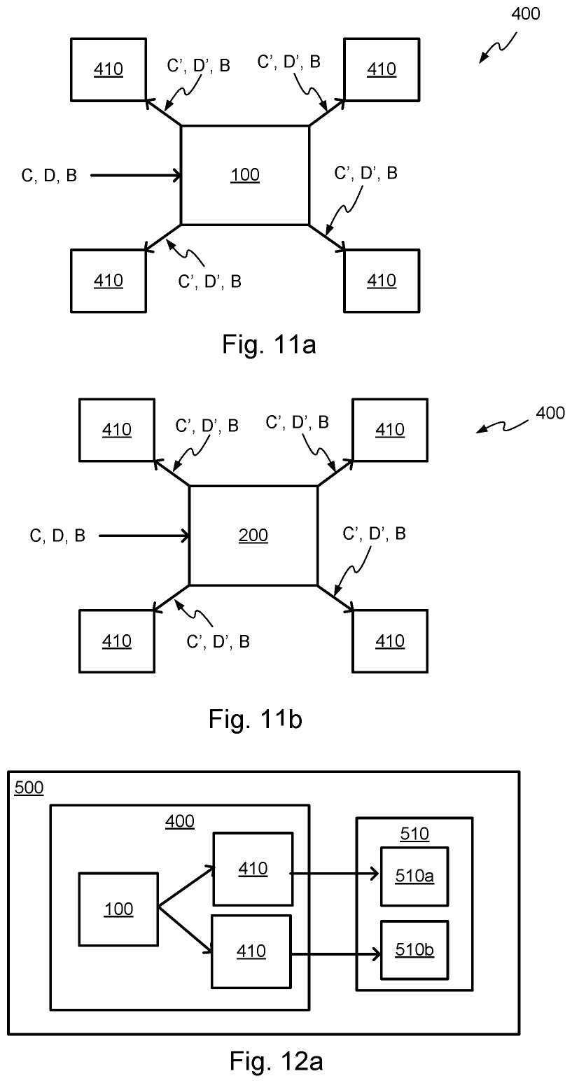

As mentioned in the background section, in order to generate the delayed signals, beam forming circuits (phase-shifters) 416 (see FIG. 11) are commonly used. As a phase-shift is not a true time delay, a time delay introduced by a phase-shift will differ depending on the frequency of the phase-shifted signal. As a simple example, adding a 360° phase-shift is equal to one a delay of one period time T of the transmitted signal. The period time T is determined by the inverse of a carrier frequency f_{c} (sometimes referred to as a central frequency) and will consequently decrease with increased carrier frequency f_{c}. In other words, a 360° phase shift will result in a shorter time delay at a higher carrier frequency f_{c} compared to a lower carrier frequency f_{c}. This effect is commonly known as beam squint is a known problem in beamforming transmitters. The issue of beam squint increase with increased relative bandwidth (RBW), i.e. a ratio between a bandwidth (BW) and the carrier frequency f_{c} of the RF signals being transmitted. The beam squint will further depend on the beam-steering angle θ and an angular error Δ introduced by the effect of beam squint may be estimated as:

$$Δ = \frac{BW}{fc} * tan θ = RBW * tan θ$$

As the tangent of the beam-steering angle θ will have its minimum at 0°, a beam direction B̅ along the z-axis in FIG. 1c, i.e. the beam-steering angle θ is 0°, will be substantially unaffected by beam squint. As the beam-steering angle θ diverges from 0°, the effect of the beam squint, i.e. the angular error Δ, will increase. In the example given above, where the fourth column of subgroups 510d, 510h, 510f, 510p were delayed the most, it is from this column of subgroups 510d, 510h, 510f, 510p the main contribution to beam squint arises.

The inventors behind the present disclosure have realized that, by delaying signals already in the digital domain based on the intended beam direction B̅, the effect of beam squint may be reduced and in some cases completely removed. That is to say, the inventors have realized that it is possible to compensate for the angular error Δ introduced by the effect of beam squint in the digital domain.

In FIG. 2, a distribution arrangement 200 is shown which comprises a, preferably, centrally located distribution device 100. The distribution device 100 is operatively connected to two or more sub-nodes 210 of the distribution arrangement 200. In FIG. 2, four sub-nodes 210 are shown, but as will be understood after digesting the full teachings of the present disclosure, there may be any plurality of sub-nodes 210 connected to the distribution device 100 and comprised in the distribution arrangement 200. The sub-nodes 210 will be further explained elsewhere in this disclosure, but it should be mentioned already now, that the sub-nodes 210 may in some embodiments be distribution devices 100 and in some embodiments leaf-nodes 410 or beamforming transmitters 410 (see FIG. 11). The distribution device 100 is configured to obtain at least a digital data signal D comprising digital data for e.g. transmission of a beamforming transmitter 410 (see FIG. 11). The digital data signal D may comprise digital data in the form of in-phase data (I data) and quadrature phase data (Q data) where each of the I data and the Q data may be formed with a plurality of digital bits corresponding to a bit resolution of the digital data signal D. The distribution device 100 is further configured to obtain a clock signal C associated with the digital data signal D, that is to say, the data signal D is clocked by the clock signal C. In addition to this, the distribution device 100 is configured to obtain a beam control signal B. The beam control signal B may be any suitable signal configured to describe the intended beam direction B̅. The beam control signal B may in some embodiments be in the form of beam weights, precoders and/or any other format known from cellular communication technologies. In some embodiments the beam control signal B may be general control signals indicating the intended beam direction B̅ in any suitably way by specifying e.g. elevation, azimuth etc of the beam direction B̅. The distribution device 100 is configured to delay the data signal D and the clock signal C based on the beam control signal B. In doing this, the distribution device 100 may introduce individual delays for each of the sub-nodes 210 of the plurality of sub-nodes 210.

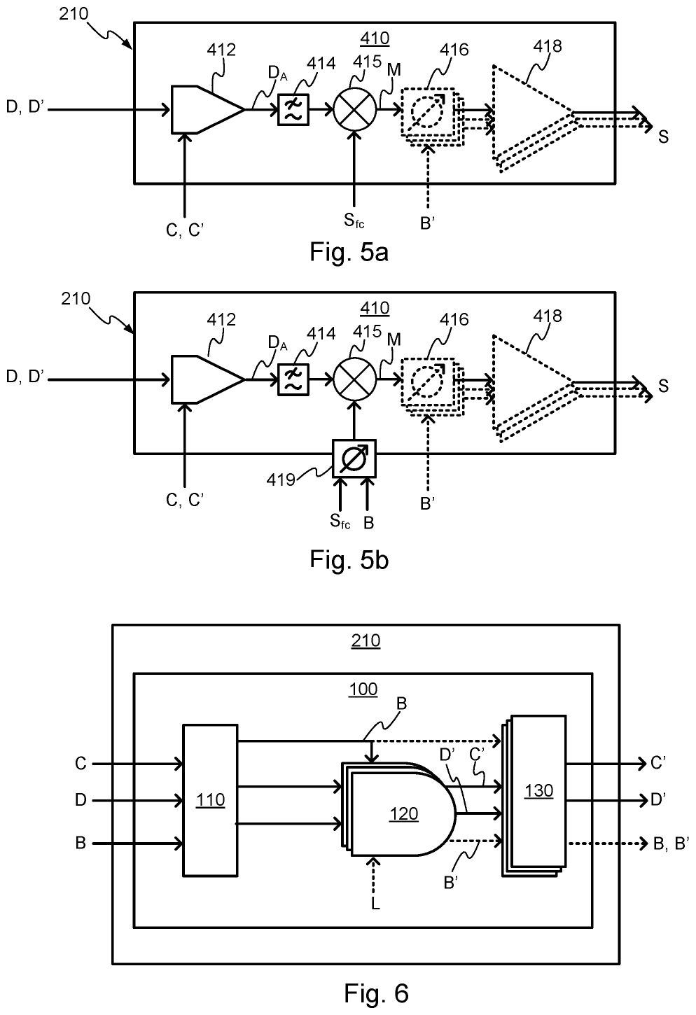

The delays introduced on the digital data signal D and the clock signal C will be true time delays. That is to say, regardless of what the BW of the digital data signal D is, all frequencies will be subjected to the same delay. As will be further explained elsewhere, depending on the delay introduced to the digital data signal D and the clock signal C, and if the digital data signal D is used for modulation of a carrier frequency f_{c}, it may be beneficial to delay the carrier frequency f_{c} the same amount as the digital data signal D and the clock signal C. However, as the carrier frequency f_{c} is a single frequency signal, its BW is substantially zero, at it will not suffer from squint. Consequently, the carrier frequency fe is preferably delayed by means of a phase-shift. A resulting modulated carrier signal M (see e.g. FIGS. 5a-b) will consequently not require beamforming by means of phase-shifters, at least no to the same extent as prior art solutions, and will not be as affected by beam squint as prior art solutions.

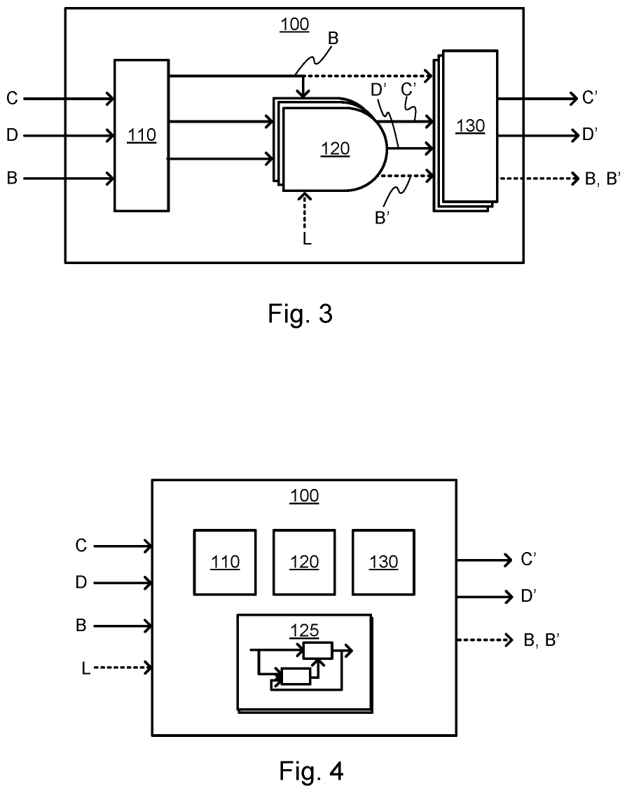

FIG. 3 shows a schematic view of a distribution circuit 100 according to some embodiments of the present disclosure. The distribution circuit 100 comprises an obtaining circuit 110, configured to obtain the digital data signal D, the clock signal C and the beam control signal B as previously presented. The distribution device 100 further comprises one or more delaying circuits 120. Each delaying circuit 120 is operatively connected to the obtaining circuit 110 to receive the digital data signal D and the clock signal C as input signals to delay. The distribution circuit 100 further comprises a provisioning circuit 130 operatively connected to the delaying circuit 120. The delaying circuit 120 is configured to delay the digital data signal D and the clock signal C based on the beam control signal B provided by the obtaining circuit 110 in order to provide the delayed data signal D′ and the delayed clock signal C′ to the provisioning circuit 130. In FIG. 3, the distribution circuit 100 is shown comprising a plurality of provisioning circuits 130. Preferably, each of these provisioning circuits 130 are configured to be connected to a sub-node 210. Similarly, the distribution circuit 100 of FIG. 3 is shown comprising a plurality of delaying circuits 120. Preferably, each of these delaying circuits 120 are operatively connected to a corresponding distribution circuit 130. In some embodiments, the distribution circuit 100 is provided with one distribution circuit 130 for each sub-node 210 to which it is configured to be connected. In such embodiments, the distribution circuit 100 may be provided with the same number of delaying circuits 120 as the number of distribution circuits 130, where each delaying circuit 120 is operatively connected to a respective distribution circuit 130. However, in some embodiments, one or more delaying circuits 120 may be configurable (configured) to work serially such that one delaying circuit 120 is configurable (configured) to provide different delayed digital data signals D′ and delayed clock signals C′ to one or more distribution circuits 130. Correspondingly, in some embodiments, one or more distribution circuits 130 may be configurable (configured) to work serially such that one distribution circuit 130 is configurable (configured) to receive different delayed digital data signals D′ and delayed clock signals C′ from one or more delaying circuits 120 and to provide different delayed digital data signals D′ and delayed clock signals C′ to different sub-nodes 210. In a preferred embodiment, the number of sub-nodes 210 to which the distribution circuit 100 is configured to be connected to, are the same as a number of distribution nodes 130 and delaying circuits 120 of the distribution circuit 100. That is to say, the number of sub-nodes 210 to which the distribution circuit 100 is configured to be connected to, are in a one to one relation with the number of distribution nodes 130 and delaying circuits 120 of the distribution circuit 100.

The delaying circuit 120 introduces a delay on the digital data signal D and the clock signal C based on the beam control signal B, and, as will be further explained elsewhere, in some embodiments it may be beneficial to also provide the beam control signal B to the sub-nodes 210. In some embodiments the delay introduced to the digital data signal D and the clock signal C may not be at the precision required by the individual antenna elements 515 e.g. where a sub-node 210 is connected to a plurality of antenna elements 515. In such embodiments, it may be beneficial to determine residual beam control signals B′ which are based on the beam control signal B and the delay introduced by delaying circuit 120. In other words, for each delayed digital data signals D′ and delayed clock signals C′ provided by the delaying circuit 120, an associated residual beam control signal B′ may be provided. The residual beam control signal B′ comprise information describing intended beam direction B̅ but processed based on the delay introduced by delaying circuit 120. To exemplify, assume that if the beam control signal B indicate, or if it is determined based on the beam control signal B, that digital data signal D and the clock signal C to a particular sub-node 210 should be delayed 4 ps. For various reasons, it may be that only 3 ps of delay is introduced by the delaying circuit 120 and a remainder of 1 ps delay remains. This remainder may be described in the residual beam control signal B′ in any suitable way. In some embodiments, the intended beam direction B̅ indicated by the beam control signal B may be provided together with the delay introduced by the delaying circuit 120 such that sub-nodes 210 may themselves normalize the beam control signal B based on the delay introduced by the delaying circuit 120 and/or the residual beam control signal B′ in order to determine if any, and if so, how much, delay is required at that particular sub-node 210. The total delay introduced to the digital data signal D and the clock signal C at each antenna element 510, preferably match the delay required to form the intended beam direction B̅. That is to say, preferably, the residual delay is zero.

In some embodiments, the delay introduced by the delaying circuit 120 may depend on a configurable relative location L of the sub-nodes 210. This configurable relative location L may be used to describe the relative location of the sub-nodes 210 in any suitable manner, and may comprise e.g. vectors, polar coordinates, electrical lengths, or other descriptive variables. The configurable relative location L is relatable to the intended beam direction B̅. That is to say, given beam control signal B and the configurable relative location L, the delaying circuit 120 (or any other processing circuit) is capable of determining a desired delay for the digital data signal D clock signal C in order to arrive at the intended beam direction B̅.

In FIG. 4, an optional embodiment of a distribution device 100 according to the present disclosure is shown. In order to increase an absolute accuracy of the distribution device 100, it may further comprise one or mode delay locked loops, DLLs, 125. The DLLs 125 are preferably constructed from cells (e.g. inverters) substantially equal to the delay introducing circuit(s) of the delaying circuit 120. The DLLs 125 are preferably clocked by a reference frequency clock and a delay of a cell will be a known fraction of a clock cycle of the reference frequency clock. In case of a plurality of DLLs, each DLL 125 may be provided with different number of cells in order to e.g. find delay fine tuning settings using interpolation from DLL 125 tuning results. That is to say, a DLL 125 with several cells may be used for coarse tuning, and DLLs 125 with fewer cells may be used for fine tuning. Having DLLs 125 enables the calibration of the absolute accuracy of the delays of the distribution device 100.

With continued reference to FIG. 4, preferably, in order to increase a relative accuracy in the delayed digital data signal D′ and the delayed clock signal C′, the sub-nodes 210 are arranged symmetrically, or at least at symmetric distances from the distribution device 100. In doing this, the time it takes for the delayed digital data signal D′ and delayed clock signal C′ to reach (from the distribution arrangement 100) one sub-node 210, will be the same as the corresponding time to reach another sub-node 210. However, in some implementations, it may not be technically possible to arrange the sub-nodes 210 such that an electrical distance for the delayed digital data signal D′ and delayed clock signal C′ between each of the sub-nodes 210 and the distribution device 100 are the same. Consequently, it may be beneficial to compensate for any difference in electrical length by introducing DLLs 125 to ensure relative accuracy. The DLLs 125 configured to calibrate the relative accuracy may be corresponding to the DLLs 125 configured to calibrate the absolute accuracy. In some embodiments, the DLLs 125 configured for calibration of absolute accuracy are the same as the DLLs configured for calibration of relative accuracy.

The embodiments presented with reference to FIG. 4 are optional and may be combined with any other suitable embodiment presented herein. It should also be mentioned that the calibration of relative accuracy may be implemented independently of the calibration of absolute accuracy and vice versa.

With reference to FIGS. 5a-b, one embodiment of a sub-node 210 will be presented. In this embodiment, the sub-node 210 comprises a leaf-node 410. In some embodiment, the sub-node 210 is a leaf-node 410.

The leaf-node 410 is configured to be connected to one or more antenna elements 515. In some embodiments, the leaf-node 410 is configured to be connected to one subgroup 510a, . . . , 510p of an antenna array 510. The leaf-node 410 is configured to provide an RF-signal S to each of the antenna element 515 it is configured to be connected to. The leaf-node 410 is provided with the delayed digital data signal D′ and the delayed clock signal C′ as inputs. For the sake of completeness, there may be embodiments where no delay is introduced by the distribution circuit 100 such that the sub-node 210 is provided with digital data signal D and the clock signal C directly, this is applicable for all embodiments although not visible in all figures. The leaf-node 410 comprises a conversion circuit 412 configured to convert the delayed digital data signal D′ to an analog data signal D_{A}. The conversion circuit 412 is clocked by the delayed clock signal C′. The conversion circuit 412 may be implemented as any suitable digital to analog converter (DAC). The leaf-node 410 further comprise a mixing circuit 415. The mixing circuit 415 is configured to mix, e.g. up-convert, the analog data signal D_{A} with a carrier frequency signal S_{fc}. In doing this, the mixing circuit 415 may provide a modulated carrier signal M.

In prior art implementations, the beamforming (e.g. delay) of the modulated carrier signal M would be introduced by a phase-shift after (partial) up-conversion of the analog data signal D_{A}. If the beamforming is performed at an intermediate frequency, it is generally referred to as LO-beamforming, and if the beamforming is performed at RF-frequencies, e.g. at the carrier frequency f_{c}, it is generally referred to as RF-beamforming. Regardless wherein in the analog domain the phase-shift is performed, the phase-shift will give rise to beam squint. The amount of beam squint will, as previously explained, depend on the RBW of the analog signal.

When the leaf-node 410 is provided with the delayed digital data signal D′ and the delayed clock signal C′ from a distribution device 100 according to the present disclosure, it is not required to perform any phase-shifting of the modulated carrier signal M. As a consequence, there will be no beam squint present.

As previously indicated, the leaf-node 410 may be configured to feed a subgroup 510a, . . . , 510p of an antenna array 510, where the subgroup comprises a plurality of antenna elements 515. Such embodiments may be formed based on design targets relating to cost, size, power consumption etc., where it is not feasible to add separate DACs 412 for each antenna element 515. As a consequence, in order to keep a beamwidth of a resulting beam comparably narrow, some embodiments of the leaf-node may 410 comprise a beamforming circuit 416 configured to phase-shift the modulated carrier signal M. Admittedly, this will introduce beam squint, but since this is only performed at the subgroups 510a, . . . , 510p of the antenna array 510 and the beamforming (i.e. delay) between the subgroup 510a, . . . , 510p is provided by the distribution device 100 according to the present disclosure in the digital domain; the amount of beamforming required at the leaf-node 416 is greatly reduced. That is to say, the steering angle θ applied by the beamforming circuit 416 is reduced compared to prior art solutions due to part of the beamforming being performed in the digital domain by the distribution device 100. The beamforming circuit 416 is consequently configured to phase-shift the modulated carrier signal M based on the residual beam control signal B′.

In some embodiments of the leaf-node 410, it may further comprise one or more filtering circuit 414 configured to filter the analog data signal D_{A}. Although only one filtering circuit 414 is shown in FIGS. 5a-b, the leaf-node 410 may comprise a plurality of filtering circuits 414. The filtering circuit 414 may be arranged between the conversion circuit 412 and the mixing circuit 415 and preferably configured as a low-pass filter. Alternatively, or additionally, the filtering circuit 414 may be arranged between the mixing circuit 415 and the antenna element 515 (not shown in FIG. 5a) and configured as a band-pass filter. The leaf-node 410 may further comprise one or more amplifiers 418 configured to amplify the modulated carrier signal M prior to it being provided to the antenna element 515.

It should be mentioned that the leaf-nodes 410 illustrated and explained in the present disclosure are simplified for efficiency. The skilled person will understand that further blocks may be desired in order to design an optimized leaf-node 410. There may be I/Q-converters, baluns, splitters (for supplying a plurality of antenna elements), power management etc. and all these are well within the scope of what the skilled person is expected to deliver.

If the carrier frequency f_{c} is comparably high and the number of antenna elements 515 comparably few, it is likely that all delays introduced by distribution device 100 are multiples of the period time T of the carrier frequency f_{c}. If that is the case, the carrier frequency signal S_{fc} may be provided directly to the mixing circuit 415 as the carrier frequency signal S_{fc} will be in phase with the analog data signal D_{A}. However, in situations where it is not sufficient to delay the digital data signal D and the clock signal C by multiples of the period time T of the carrier frequency f_{c}, it is beneficial to introduce a carrier phase-shifting circuit 419, see FIG. 5b, in a signal path of the carrier frequency signal S_{fc}. The carrier phase-shifting circuit 419 is configured to ensure that the carrier frequency signal S_{fc} is provided to the mixing circuit 415 with the same delay as the delayed digital data signal D′ and the delayed clock signal C′ has been subjected to. That is to say, the carrier phase-shifting circuit 419 is configured to delay the carrier frequency signal S_{fc} by substantially the same amount as the digital data signal D and the clock signal C has been delayed before arriving at the mixing circuit 415. As the carrier frequency signal S_{fc} is a single frequency signal at the carrier frequency f_{c}, the bandwidth is zero, implementing the carrier phase-shifting circuit 419 as a phase-shift may be done without introducing any beam squint. The carrier phase-shifting circuit 419 is preferably configured to phase-shift the carrier frequency signal S_{fc} based on the beam control signal B. As the carrier frequency signal S_{fc} is without modulation and periodic, it is sufficient to phase-shift the carrier frequency signal S_{fc} between 0 and 360°, full periods may be disregarded and the phase-shift may be determined as the remainder when fractioning the total phase shift by 360°. It should be mentioned that the carrier phase-shifting circuit 419 may be external to the leaf-node 410 in some embodiments, and comprised in the lead node 410 in some embodiments.

In FIG. 6, an alternative embodiment of the sub-node 210 is shown. The sub-node of FIG. 6 comprises a distribution circuit 100 according to any of the embodiment presented herein. This allows the formation of a tree-like structure where a, preferably, centrally located distribution circuit 100 is connected to sub-nodes 210 which in turn are connected to other sub-nodes 210 and/or leaf-nodes 410.

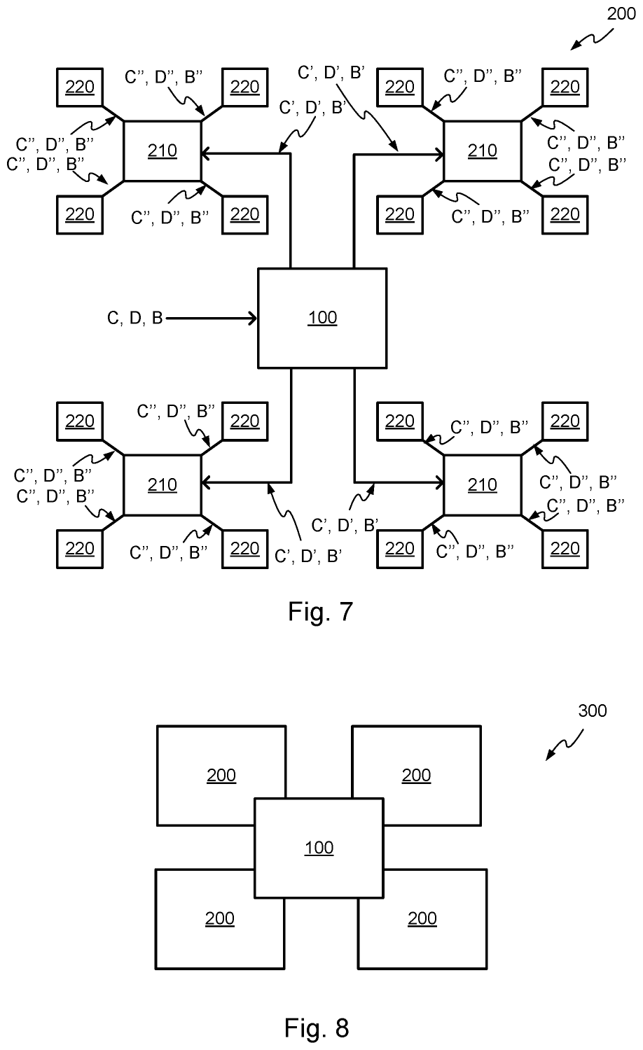

As seen in FIG. 7, a sub-node 210 as described with reference to FIG. 6 may be utilized to form a distribution arrangement 200. The distribution arrangement 200 comprises one distribution device 100 connected to a first plurality of sub-nodes 210. In FIG. 7, the first plurality of sub-nodes 210 contains four sub-nodes 210, but this is but one example and any plurality of sub-nodes 210 may be comprised in the first plurality of sub-nodes 210 of the distribution arrangement 200. The distribution device 100 is configured to provide each of the sub-nodes 210 of the first plurality of sub-nodes 210 with delayed digital data signals D′ and delayed clock signals C′, each signal D′, C′ delayed individually for the associated sub-node 210 and based on the beam control signal B. In this embodiment, the distribution device 100 is further configured to provide each of the sub-nodes 210 of the first plurality of sub-nodes 210 with residual beam control signals B′ which are based on the beam control signal B and the individual delay provided on the delayed digital data signal D′ and the delayed clock signal C′ for the associated sub-node 210. In this exemplary embodiment, each of the sub nodes 210 of the first plurality of sub-nodes 210 comprise a distribution device 100 according to the present disclosure. This enables each of the first sub-nodes 210 of the first plurality of sub-nodes 210 to be connected to a respective second plurality of sub-nodes 220. The distribution devices 100 of each of the sub-nodes 210 of the first plurality of sub-nodes 210 is configured to provide each of the sub-nodes 220 of the second plurality of sub-nodes 220 with delayed digital data signals D″ and delayed clock signals C″, each signal D″, C″ delayed individually for the associated sub-node 220 and based on the beam control signal B. The each distribution device 100 of the sub-nodes 210 of the first plurality of sub-nodes 210 is further configured to provide each of the sub-nodes 220 of the second plurality of sub-nodes 220 with residual beam control signals B″ which are based on the residual beam control signal B′ provided by the distribution device 100 (the central distribution device 100) and the individual delay provided on the delayed digital data signal D″ and the delayed clock signal C″ for the associated sub-node 220.

It should be mentioned that although FIG. 7 is shown as symmetrical with regards to the number of sub-nodes 220 of the second plurality of sub-nodes 220 that are connected to each sub-node 210 of the first plurality of sub-nodes 210, this is one example. Embodiments exist wherein each sub-node 210 of the first plurality of sub-nodes 210 may be connected to any number of sub-nodes 220, and not necessarily the same number of sub-nodes 220 as the other sub-nodes 210 of the first plurality of sub-nodes 210.

More layers may be added to the hierarchical architecture shown in FIG. 7, and in FIG. 8, an embodiment of a distribution assembly 300 is shown. The distribution assembly 300 comprises a distribution device 100 according to the present disclosure and a plurality of distribution arrangements 200 according to the present disclosure. In FIG. 8, the distribution assembly 300 comprise four distribution arrangements 200, but this is to exemplify, and a distribution assembly 300 may comprise any plurality of distribution arrangements 200.

It is clear from the present disclosure and e.g. FIGS. 2, 7 and 8, that the hierarchical architecture may be extended with as many layers/levels as desired. The more layers that are added, the shorter individual delays are introduced by the distribution circuits 100 as these delays are based on the sub-nodes 210 connected to them and the beam control signal B.

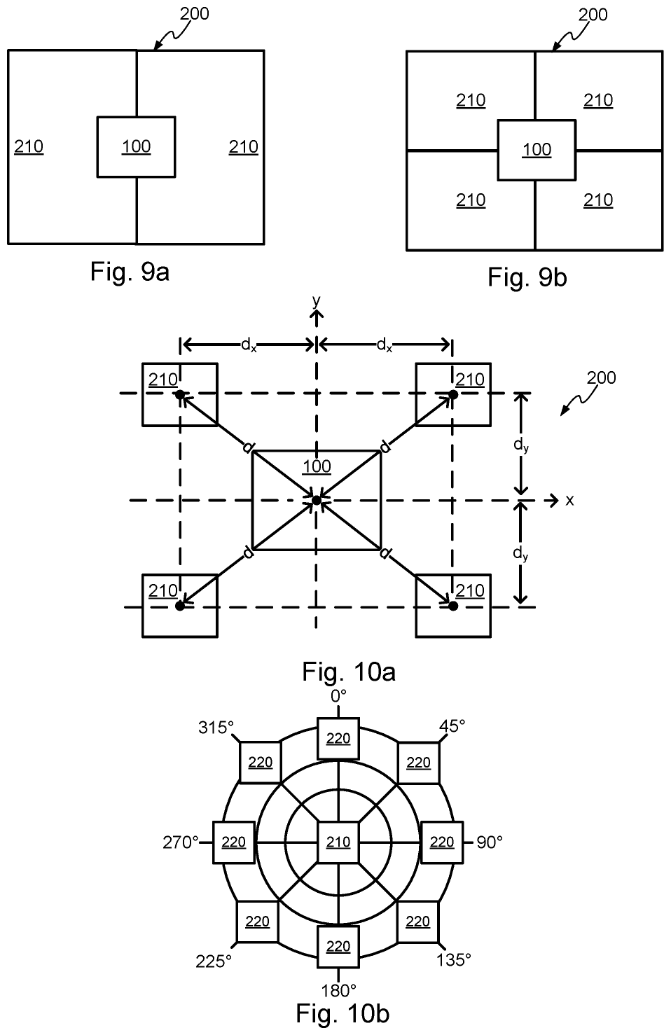

As previously indicated, for a distribution arrangement 200, it is beneficial, although not required, to distribute (e.g. place, arrange) the sub-nodes 210 symmetrically about (around) the distribution device 100. This implies placing the distribution device 100 geometrically centered in the distribution arrangement 200. This is illustrated in FIGS. 9a and b, where in FIG. 9a, the distribution arrangement 200 comprises two sub-nodes, arranged at opposite sides of the distribution device 100. In the embodiment of FIG. 9b, the distribution arrangement 200 comprises four sub-nodes 210 which are arranged symmetrically about the distribution device 100. As illustrated in FIGS. 9a-b, the distribution device 100 may in some embodiments physically overlap the sub-nodes 210, this may be accomplished by e.g. multilayered or stacked designs.

The symmetrical design is even more apparent when looking to FIGS. 10a and b, these Figs. will also be utilized to present some embodiments of the configurable relative location L. In FIG. 10a, a distribution arrangement 200 is shown comprising four sub-nodes 210. The sub-nodes 210 are placed in an XY-coordinate system with the distribution circuit 100 located at the origin of the coordinate system. All sub-nodes are arranged at a distance d from the distribution circuit 100 which is described as a distance dₓ along an x-axis and a distance d_{y} along the y-axis. Expressed in [x,y]-coordinates, this implies that a first sub-node 210 is located at [−dₓ, d_{y}] (upper left corner) a second sub-node 210 is located at [dₓ, d_{y}] (upper right corner), a third sub-node is located at [dₓ,−d_{y}] (lower right corner) and a fourth sub-node 210 is located at [−dₓ,−d_{y}] (lower left corner).

In FIG. 10b, a partial view of a distribution arrangement 300 is shown, where the second plurality of sub-nodes contains eight sub-nodes 220 connected to one of the sub-nodes 210 of the first plurality of sub-nodes 210. In this embodiment, the second plurality of sub-nodes 220 are symmetrically arranged about, i.e. around, the first sub-node 210. A distance from the first sub-node 210 to each of the sub-nodes 220 of the second plurality of sub-nodes 220 is substantially equal. Further to this, an angle between the first sub-node 210 and two neighboring sub-nodes 220 of the second plurality of sub-nodes 220 is substantially the equal for all of the sub-nodes 220 of the second plurality of sub-nodes 220. In the example illustrated in FIG. 10b, this implies that the sub-nodes 220 of the second plurality of sub-nodes 220 are spaced apart by 45°, i.e. the number of sub-nodes 220 connected to the central sub-node 210 divided by 360°. In embodiments like this one, it may be beneficial to indicate the configurable relative location L using e.g. polar coordinates.

With reference to FIGS. 11a-b, a beamforming device 400 according to the present disclosure will be presented. In FIG. 11a, the beamforming device 400 comprises a distribution device 100 according to the present disclosure connected to a plurality of leaf-nodes 410 according to the present disclosure. The leaf-nodes 410 may be the leaf-nodes 410 presented with reference to FIGS. 5a-b. In FIG. 11a, the distribution device 100 is connected to four leaf-nodes 410, but it should be mentioned that the distribution device 100 may be connected to any plurality of leaf-nodes 410. As previously explained, the distribution device 100 is configured to obtain the digital data signal D, the clock signal C and the beam control signal B and to provide respective delayed digital data signal D′ and delayed clock signal C′ to each of the leaf-nodes 410.

In FIG. 11b, another embodiment of the beamforming device 400 is shown. In FIG. 11b, the beamforming device 400 comprise a distribution arrangement 200 according to the present disclosure connected to a plurality of leaf-nodes 410 according to the present disclosure. The leaf-nodes 410 may be the leaf-nodes 410 presented with reference to FIGS. 5a-b. In FIG. 11b, the distribution arrangement 200 is connected to four leaf-nodes 410, but it should be mentioned that the distribution arrangement 200 may be connected to any plurality of leaf-nodes 410. The distribution arrangement 200, e.g. the distribution device 100 of the distribution arrangement 200, is configured to obtain the digital data signal D, the clock signal C and the beam control signal B and to provide a respective delayed digital data signal D′, delayed clock signal C′ and optionally residual beam control signal B′ to each of the leaf-nodes 410.

Although not shown, the beamforming device 400 may comprise a plurality of distribution arrangements 200, distribution devices 100, one or more distribution assemblies 300 or combinations of thereof. The beamforming device 400 may, in other words, be configured with any number of levels, wherein at least one comprises a distribution device 100 according to the present disclosure. The beamforming device 400 comprise at least one leaf-node 410.

For the sake of completeness, it should be mentioned that although the distribution device 100 is configured to obtain the digital data signal D, the clock signal C and the beam control signal B and to provide respective delayed digital data signal D′ and delayed clock signal C′ to each of the sub-nodes 210, 220 connected to it, there may be beam control signals B, embodiments, or situations where not all sub-nodes 210, 220 are to receive delayed signals D′, C′. The skilled person will understand, after reading the present disclosure, that it is also within the scope of the present disclosure to provide delayed signals D′, C′ to one or more sub-nodes 210, 220, and provide the digital data signal D and the signal C substantially without delay to other sub-nodes 210, 220 and/or not to provide any signal to other sub-nodes 210, 220.

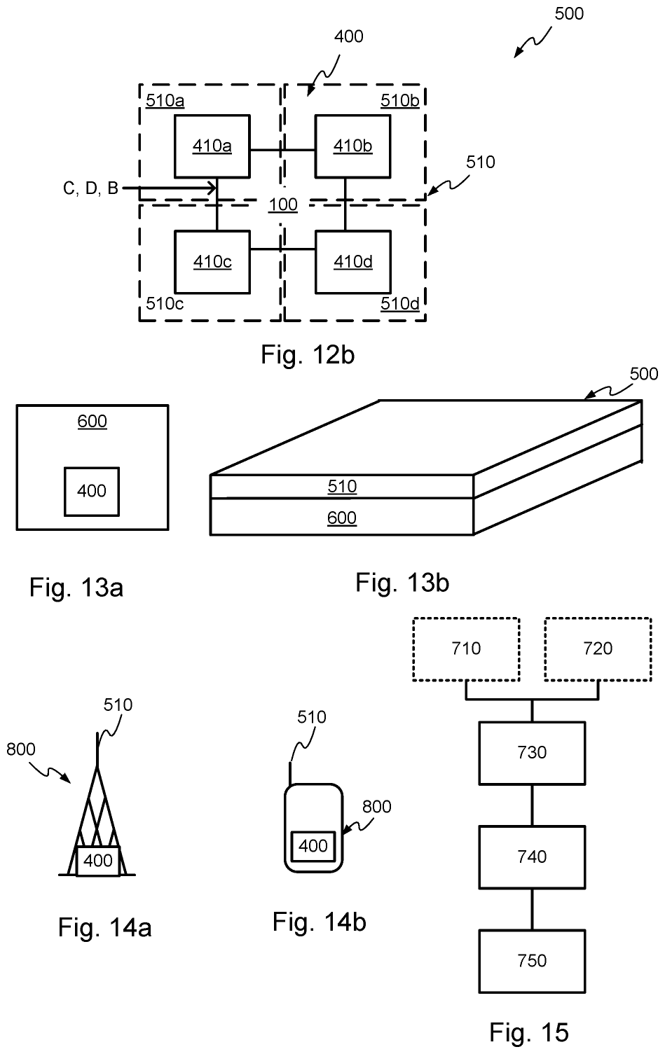

In FIG. 12a, a beamforming assembly 500 is shown. The beamforming assembly 500 comprise one or more beamforming device 400 as presented herein and an antenna array 510 as presented herein. At least one of the leaf-nodes 410 of the beamforming device 410 is connected to an antenna element 515 of the antenna array 510. In some embodiments, each antenna element 515 of the antenna array 510 are connected to a respective a leaf-node 410. As previously mentioned, in order to reduce e.g. cost, design area, power consumption etc., it may be beneficial to have some of the leaf-nodes 410 providing RF-signals S to more than one antenna element 515. In other words, the antenna array 510 may, as previously explained, be divided into a plurality of subgroups 510a, . . . , 510p where each subgroup 510a, . . . , 510p comprise at least one antenna element 515. In a preferred embodiment, each subgroup 510a, . . . , 510p comprise a plurality of antenna elements 515. In such embodiments, each subgroup 510a, . . . , 510p is connected to a respective leaf node 410 of the beamforming device 400.

In FIG. 12b, a schematic top view of a beamforming assembly 500 is shown. In FIG. 12b, the antenna array 510 is divided into four subgroups 510a, 510b, 510c, 510d. Each of these subgroups 510a, 510b, 510c, 510d is connected to a respective leaf-node 410a, 410b, 410c, 410d which receives respective delayed digital signals D′ and delayed clock signals C′ from a distribution device 100 of the beamforming assembly 500. As seen in FIG. 12b, the antenna array 500 is overlaid the leaf-nodes 410a, 410b, 410c, 410d and the distribution device 100. The leaf-nodes 410a, 410b, 410c, 410d are preferably arranged central to their associated subgroup 510a,0 510b, 510c, 510d of the antenna array 500, this is to ensure substantially equal distance from the leaf-leaf node 410a, 410b, 410c, 410d to each antenna element 515 of the associated subgroup 510a, 510b, 510c, 510d. As previously indicated, the distribution device 100 is preferably located with substantially equal distances to each of the leaf-nodes 410a, 410b, 410c, 410d.

With reference to FIG. 13a, an integrated circuit (IC) 600 will be presented. The integrated circuit 600 comprises a beamforming device 400 according to the present disclosure, e.g. as described with reference to FIGS. 11a-b. The IC 600 may be designed using any suitable technology and may, in some embodiments, be an IC 600 based on CMOS technology. The IC 600 of FIG. 13a comprises a beamforming arrangement 400 as presented herein. In some embodiments, not shown, the IC 600 may comprise a distribution device 100 as presented herein, a distribution arrangement 200 as presented herein, or a distribution assembly 300 as presented herein.

In FIG. 13b, an exemplary embodiment of a beamforming assembly 500 is illustrated, wherein an antenna array 510 of the presented disclosure is connected to the IC 600 of FIG. 13a. This allows for a compact beamforming assembly 500 with (compared to the prior art) improved freedom in beam-steering due to reduced beam squint.

In FIGS. 14a-b, apparatuses 800 comprising the beamforming device 400 as presented herein is shown. The apparatuses 800 comprise one or more antenna arrays 510 connected to the beamforming device 400. In a preferred embodiment, the apparatus 800 is a network node 800. In FIG. 14a, a specific embodiment of the apparatus 800 is shown, wherein it is a network node 800 in the form of a base station (BS) 800. In FIG. 14b, another specific embodiment of the apparatus 800 is shown, wherein it is a network node 800 in the form of a wireless device 800, preferably a user equipment (UE) 800.

With reference to FIG. 15, a method 700 for signal distribution will be presented. Specifically, the method 700 is for distribution of the digital data signal D its associated clock signal C to a plurality of sub-nodes 210, 220. The method 700 may be performed by any suitable controller, processer etc. The method 700 is preferably performed by means of a distribution device 100 as presented herein.

The method 700 comprises obtaining 730 of the digital data signal D, the clock signal C, and the beam control signal B. The signals D, C, B are the same signals D, C, B as previously presented herein. The signals D, C, B may be obtained in any suitable manner, across any suitable interface and at any suitable point in time. The obtaining 730 of the signals D, C, B may be performed by means of an obtaining circuit 110 as presented herein.

The method 700 further comprises delaying 740 the digital data signal D and the clock signal C as previously presented. This means the digital data signal D and the clock signal C are delayed based on the beam control signal B. The delayed digital data signal D′ and the delayed clock signal C′ are provided 750 to the respective one or more of the plurality of sub-nodes 210, 220. The delaying 740 may be performed by means of the delaying circuit 120 as presented herein.

Optionally, the method 700 may comprise calibrating 710 a first signal delay. This is to adjust for a signal delay (i.e. the time it takes for a signal to reach the sub-nodes 210, 220) to one or more of the plurality of sub-nodes 210, 220, i.e. to increase the absolute accuracy of the delay. The first signal delay may be given in relation to a period the clock signal C. The calibrating 710 may be performed by means of one or more TDDs 125 as presented elsewhere.

In some optional embodiments, the method 700 may comprise calibrating 720 a second signal delay. This is to adjust for a difference (if any) in the signal delay between two or more of the plurality of sub-nodes 210, 220, i.e. to increase the relative accuracy of the delay. The second signal delay may be given in relation to a period the clock signal C. The calibrating 720 may be performed by means of one or more TDDs 125 as presented elsewhere.

In further optional embodiments of the method 700, it comprises phase-shifting 750 a carrier frequency signal S_{fc}. The carrier frequency signal S_{fc} is for subsequent mixing with an analog data signal D_{A} associated with a delayed digital data signal D′. The phase-shifting 750 is performed with a phase-shift that substantially corresponds to the time-delay introduced to the associated delayed digital data signal D′. The phase-shifting may be performed by means of the carrier phase-shifting circuit 419 as presented herein.

The skilled person will understand, after understanding the full teaching of the present disclosure, that the method 700 may be extended to comprise any of the teachings herein. For instance, in some embodiments, the phase-shifting 750 may alternatively, or additionally, phase-shift the modulated carrier signal M based on e.g. the residual beam control signal B′, e.g. by means of the beamforming circuit 416 as presented herein.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference to wireless beamforming transmitters, persons skilled in the art will appreciate that the embodiments of the invention can equivalently be applied to any other signal distribution circuit where phase-shifts and timing is of the essence. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A distribution device for distribution a digital data signal and an associated clock signal to a plurality of sub-nodes, the distribution device comprising:
an obtaining circuit, configured to obtain the digital data signal, the clock signal and a beam control signal indicating a target beam direction for the digital data signal;
a delaying circuit, configured to, individually for one or more of the plurality of sub-nodes, delay the digital data signal and the clock signal based on the beam control signal, thereby providing a delayed digital data signal and a delayed clock signal; and
a provisioning circuit, configured to provide the delayed digital data signal and the delayed clock signal to the respective one or more of the plurality of sub-nodes.

2. The distribution device of claim 1, further comprising a delay locked loop, DLL, configured to align a signal delay to the one or more of the plurality of sub-nodes in relation to a period of the clock signal.

3. The distribution device of claim 1, further comprising a DLL configured to adjust a difference in the signal delay between two or more of the plurality of sub-nodes in relation to the period of the clock signal.

4. The distribution device of claim 1, wherein the provisioning circuit is further configured to provide the beam control signal to the respective one or more of the plurality of sub-nodes.

5. The distribution device of claim 1, wherein the digital data signal is obtained on a parallel interface.

6. A distribution arrangement, comprising:
a distribution device for distribution a digital data signal and an associated clock signal to sub-nodes, the distribution device comprising:
an obtaining circuit, configured to obtain the digital data signal, the clock signal and a beam control signal indicating a target beam direction for the digital data signal;
a delaying circuit, configured to, individually for one or more of the sub-nodes, delay the digital data signal and the clock signal based on the beam control signal, thereby providing a delayed digital data signal and a delayed clock signal; and
a provisioning circuit, configured to provide the delayed digital data signal and the delayed clock signal to the respective one or more of the sub-nodes; and
a first plurality of the sub-nodes connected to the distribution arrangement.

7. The distribution arrangement of claim 6, wherein the first plurality of sub-nodes are located at substantially equal distances from the distribution device.

8. The distribution arrangement of claim 6, wherein the first plurality of sub-nodes are substantially symmetrically arranged about the distribution device.

9. The distribution arrangement of claim 6, wherein at least a first sub-node of a first plurality of sub-nodes is connected to a second plurality of sub-nodes, wherein the first sub-node comprises the distribution device.

10. (canceled)

11. (canceled)

12. (canceled)

13. A beamforming device, comprising a distribution arrangement, the distribution arrangement comprising:
a distribution device for distribution a digital data signal and an associated clock signal to sub-nodes, the distribution device comprising:
an obtaining circuit, configured to obtain the digital data signal, the clock signal and a beam control signal indicating a target beam direction for the digital data signal;
a delaying circuit, configured to, individually for one or more of the sub-nodes, delay the digital data signal and the clock signal based on the beam control signal, thereby providing a delayed digital data signal and a delayed clock signal; and
a provisioning circuit, configured to provide the delayed digital data signal and the delayed clock signal to the respective one or more of the sub-nodes; and
a first plurality of the sub-nodes connected to the distribution arrangement; and
at least one of the sub-nodes is being a leaf-node, the leaf node comprising:
a conversion circuit clocked by the delayed clock signal and configured to convert the delayed digital signal to an analog data signal; and
a mixing circuit, configured to mix the analog data signal with a carrier frequency signal, thereby providing a modulated carrier frequency signal.

14. The beamforming device of claim 13, wherein the leaf-node further comprises a beamforming circuit, configured to phase-shift the modulated carrier frequency signal based on the beam control signal.

15. The beamforming device of claim 14, wherein the beamforming circuit is configured to phase-shift the modulated carrier frequency signal based on a residual beam control signal, wherein the residual beam control signal is determined based on the beam control signal and the delay introduced to the digital data signal and the clock signal by the delaying circuit of the distribution circuit when providing the delayed digital data signal and the delayed clock signal.

16. The beamforming device of claim 13, further comprising a carrier phase-shifting circuit configured to subject the carrier frequency signal to a phase-shift corresponding to the delay introduced to the digital data signal and the clock signal by the delaying circuit when providing the delayed digital data signal and the delayed clock signal, prior to the carrier frequency signal being provided to the mixing circuit.

17. The beamforming device of claim 13, wherein the leaf-node further comprises:
a filtering circuit, configured to filter the analog data signal; and
an amplifier, configured to amplify the phase-shifted analog data signal.

18. The beamforming device of claim 14, comprising a plurality of beamforming circuits and amplifiers, wherein each beamforming circuit is configured to be operatively connected to an antenna element.

19. The beamforming device of claim 13, wherein a relative bandwidth, RBW, of the modulated carrier frequency signal is above 1%, preferably above 3% and more preferably above 5%.

20.-26. (canceled)

27. A method for distributing a digital data signal and an associated clock signal to a plurality of sub-nodes, the method comprising:
obtaining the digital data signal, the clock signal, and a beam control signal indicating a target beam direction for the digital data signal;
delaying, individually for one or more of the plurality of sub-nodes, the digital data signal and the clock signal based on the beam control signal, thereby providing a delayed digital data signal and a delayed clock signal; and
providing the delayed digital data signal and the delayed clock signal to the respective one or more of the plurality of sub-nodes.

28. The method of claim 27, further comprising:
calibrating a first signal delay to adjust for a signal delay to one or more of the plurality of sub-nodes in relation to a period of the clock signal.

29. The method of claim 27, further comprising:
calibrating a second signal delay to adjust for a difference in the signal delay between two or more of the plurality of sub-nodes in relation to a period of the clock signal.

30. The method of claim 27, further comprising:
for at least one of the sub-nodes, phase-shifting, a carrier frequency signal for subsequent mixing of an analog representation of the associated delayed digital signal, with a phase-shift corresponding to the delay introduced to the digital data signal and the clock signal when providing the delayed digital data signal and the delayed clock signal.
